(19) United States
(12) Patent Application Publication
(10) Pub. No.: US 2015/0032766 A1
(43) Pub. Date: Jan. 29, 2015

(54) SYSTEM AND METHODS FOR THE PRESENTATION OF MEDIA IN A VIRTUAL ENVIRONMENT

(71) Applicant: Eric A. Greenbaum, Great Neck, NY (US)

(72) Inventor: Eric A. Greenbaum, Great Neck, NY (US)

(21) Appl. No.: 14/446,106

(22) Filed: Jul. 29, 2014

Related U.S. Application Data
(60) Provisional application No. 61/859,736, filed on Jul. 29, 2013.

(51) Int. Cl. G06F 17/30

(52) U.S. Cl. CPC G06F 17/30061
USPC 707/756

(57) ABSTRACT

Virtual environment function tags are generated for media to play or be consumed in a dynamic virtual environment. A media player in a virtual environment plays media and a computer rendering the virtual environment detects virtual environment function tags associated with the media and alters the virtual environment in response to the virtual environment function tags.

### STATEMENT OF PRIORITY

This application claims the benefit of priority from U.S. provisional application No. 61859736 filed on 29 Jul. 2013.

### FIELD OF THE INVENTION

The present invention relates to methods for presenting media programs in a virtual reality environment.

### BACKGROUND OF THE INVENTION

Virtual reality has become a viable technology for the presentation of media. Gaming has thus far been a major focus of virtual reality media but other forms of media are amenable to the immersive nature of the technology. Many groups are developing new forms of media specifically adapted for presentation in virtual reality. However, there is a plethora of media such as, movies, television shows, other videos, music, audio programs, audio books, e-books, and the like (“legacy media”) that users want to consume in a virtual environment. To date various solutions for presenting legacy media to users in a virtual environments have been developed, however none of these solutions adequately takes advantage of the unique immersive qualities of virtual reality. Therefore there is a need in the art for a solution to present legacy media to users in a virtual environment that creates an engaging and immersive experience for users.

### SUMMARY OF THE INVENTION

An embodiment is a computer based method of presenting media, such as audio, text and/or visual content in a virtual environment. In embodiments the virtual environment (VE) is dynamic, changing with thematic or setting elements substantively related to the content of the media. In other embodiments, the virtual environment is static, providing a pleasant environment in which to consume the media. In some embodiments the VE will further comprise a presentation agent which is alternatively anthropomorphic or non-anthropomorphic.

An embodiment is a method for presenting media in a virtual environment. The method includes identifying at least one substantive element of a media program, the at least one substantive element of the media program being the subject of a VE instance, selecting a VE template, loading data from a database into the VE template, the data being related to the at least one substantive element of the media program, and rendering the VE instance, the VE including the VE template. As used herein the VE template defines the basic structure of a VE i.e., rooms, doors, halls, terrain features, etc of a virtual environment. A VE instance is a live, running VE created and instantiated based on a template. Once instantiated, the VE is populated with avatars and data. Creation of VE templates is typically performed at a different time than a user actually experiences the media program in the VE.

Another embodiment is, a system for constructing VE substantively related to a media program is provided. The system includes a template selector, the template selector for selecting a VE template related to at least one substantive aspect of the media program, the at least one substantive aspect being the subject of a VE instance, a database, the database for storing data related to at least one substantive aspect of a media program, and a processor, the processor for loading data related to the at least one substantive aspect of the media program from the database into the VE template, the VE template included in the VE.

Another embodiment is a virtual environment adapted for presenting media content to at least one user. The VE adapted for presenting media content to at least one user may be a bespoke VE specifically tailored to a given work of media content, or it may be a VE template with variable elements that can be customized for various works.

Another embodiment is a computer readable file containing media (audio, visual or combinations thereof) content adapted for being presented in a VE. The computer readable file further comprising VE function tags. VE function tags can be general attribute tags, setting tags, accent tags and/or motion capture data of a presenter/performer of the media content.

Another embodiment is a method for coding a media program for presentation in a VE comprising the steps of tagging the media content with VE function tags (general attribute tags, setting tags, accent tags and/or motion capture data of a present/performer of the audio content).

Another embodiment is a system for coding a media program for presentation in a VE. The system comprising a means for playing a program to a coder, a means for allowing the coder to input VE function tags. A means for inputting setting and/or attribute tags as a function of temporal position of the media content. The system may further comprise a means for recording a media program by a performer/presenter and/or a means of motion capturing the movements of the performer/presenter.

Another embodiment is a system for presenting media content in a virtual environment. The system comprises a computer readable media file, a virtual environment with dynamic attributes, information relevant to altering the virtual environment to match substantive elements of the media program.

Another embodiment is a database containing information on a plurality of media programs where the information is capable of being communicated to a rendering engine that renders a virtual environment so that the rendering of the virtual environment can be altered in accordance with the information contained in the database.

Another embodiment is a method of presenting didactic media content in a virtual environment. The method comprising the steps of tagging the media content with VE function tags such as general attribute tags, setting tags, accent tags and/or motion capture data of a present/performer of the media content. The didactic media content may also be tagged with figure tags which cause the virtual environment to display visuals adapted to aid in the presentation of the didactic material.

Another embodiment is a method for improving retention of didactic material in a user. The method comprises presenting didactic information to a user in a virtual environment wherein the VE takes on distinct attributes associated with particular didactic material so that the user associates the particular didactic material with the distinct attributes of the virtual environment.

Another embodiment is a method for presenting text to a user in a virtual environment where attributes of the virtual environment change in response to substantive elements of the material conveyed by the text.

### BRIEF DESCRIPTION OF DRAWINGS

FIG. 1 is a block diagram illustrating a system 100 for presenting media in a virtual environment (“VE”), according to one embodiment disclosed herein.

FIG. 2 is a flow chart depicting a method 200 for presenting media to a user in a virtual environment, according to one embodiment disclosed herein.

FIG. 3 is a flow chart depicting a method 300 for altering the VE in accordance with substantive elements of the media program as mediated by VEFTs, according to one embodiment disclosed herein.

FIG. 4 is a high-level block diagram illustrating a detailed view of the VE Function Tag (VEFT) server 400 according to one embodiment disclosed herein.

FIG. 5 is a high-level block diagram illustrating a detailed view of the Effects/Assets module according to one embodiment disclosed herein.

FIG. 6 is a flow chart depicting a method 600 for presenting textual media to a user in a virtual environment, according to one embodiment disclosed herein.

FIG. 7 is a high-level block diagram illustrating an exemplary manner in which various VEs are presented to a user during the presentation of media according to one embodiment disclosed herein.

FIG. 7a is a high level block diagram illustrating the various elements that make up a VE according to one embodiment disclosed herein.

FIG. 8 shows an example of a user interface (“UI”) for a method of coding VEFTs to be associated with a media file according to one embodiment disclosed herein.

FIG. 8a shows a schematic representation of a media file with VEFTs inserted therein according to one embodiment disclosed herein.

FIG. 8b illustrates how a view from windows in a VE change as the computer rendering the VE encounters VEFTs according to one embodiment disclosed herein.

FIG. 9 is a flow chart depicting the overall method 900 for presenting media to a user in a virtual environment, according to one embodiment disclosed herein.

FIG. 10 is a flow chart depicting the method 1000 for coding media to be presented to a user in a virtual environment, according to one embodiment disclosed herein.

FIG. 11 is a flow chart depicting the method 1100 for presenting didactic media to a user in a virtual environment, according to one embodiment disclosed herein.

FIG. 12 is a flow chart depicting the method 1200 for improving retention of didactic material in a user, according to one embodiment disclosed herein.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The term “Virtual Environment” (“VE”) shall be construed broadly to encompass an immersive virtual reality or augmented reality wherein at least a substantial portion of the environment is rendered by a computer and displayed to a user via an immersive display. Examples of immersive displays include a head mounted display (“HMD”) or CAVE. Virtual environments may be constructed by any means known to those having skill in the art. A particularly useful example are those environments created by video game designers as those environments are currently rendered in 3D and are associated with many of the elements necessary for creating a convincing immersive experience. VEs can be constructed by any methods known to those having skill in the art, such as, for example using the Unity brand or Unreal brand game development platforms.

The VEs include a variety of attributes. The attributes may change based on user selection or automatically as a media program progresses, such as based on attribute, accent or setting tags (collectively “VE function tags” or “VEFT”) coupled to the media program and in communication with a rendering engine that renders the VE. The attributes may include, but not be limited to, various types, for example: weather, time of day, view, seasonal attributes, ambient environmental noise (beach sounds, library sounds, fire sounds, forest sounds, city sounds,) and the like.

Each attribute type may be associated with various specific states, each associated with specific effects/assets. For example attribute type 1 may be the weather in the virtual environment and the various states, rendered in the VE by specific effects/assets, could be rain, sunshine, cloudy, snow, thunder, lightning and the like. In embodiments, the media program is associated with VEFTs that signal the rendering engine to render various states of various attributes, either as function of time of the media program or as a function of the media program generally.

In some embodiments the media program is an audio program, such as an audio book, or a video program such as a movie or television show. An audio book, or video program, may comprise a story wherein the story takes place in various settings, as in, for example, a forest, beach, library, city, a ship at sea, a space faring vessel, and the like. In order to increase immersion and enjoyment of a user, the virtual environment takes on a setting similar or in some way related to that of the story. For example, if the protagonist (or any other character) is on a beach in a tropical locale, the virtual environment may be a tropical beach. Similarly if the story takes place in Paris, Hong Kong, (or any other recognizable city,) the virtual environment may be a balcony overlooking that city, or a park bench in that city or some other environs indicative of the setting or the like.

A media program may comprise a story with various thematic elements. The virtual environment may be rendered to coincide with the thematic elements of the program. For example a story may focus on political intrigue and take place in various settings, regardless, the virtual environment can be rendered to highlight the political aspect of the story, as in, for example by rendering the environment such as an apartment with a view overlooking Washington D.C. By way of another illustrative, non limiting example, a story focusing on military matters may render a virtual environment of the deck of an aircraft carrier or other suitably militaristic environment. In the case of a musical program, the music may comprise “light” happy or “dark” sad/forboding elements that may be represented in the VE, as in, for example changing lighting, weather or the like. Alternatively, more explicit elements may be present in an audio program, such as in Vivaldi's the Four Seasons, in which each movement is representative of a season. In this example, the VE may take on characteristics indicative of particular seasons.

The virtual environment may be independent from the setting and/or thematic elements of the media program. It may be desirable to have a setting conducive to the enjoyment of an media program that is independent from setting or thematic elements of the media program. For example a virtual environment appointed to mimic a library with a fireplace may be a desirable location to enjoy a media program regardless of the content of the media program. Therefore a user may have the option to select from a plurality of virtual environments in which to consume to the media program irrespective of the content of the media program.

Hybrid environments are also contemplated such as, for example, a room with windows overlooking an environment. In this example, the room may remain static as the media program progresses, but the scene outside the windows may change to reflect elements of the media program. For example, if the weather associated with the media program changes, the weather outside the windows may change in accordance with the weather associated with the media program. For example as Vivaldi's 4 Seasons progresses or an audio book character finds herself in a thunderstorm. In another example, as the location setting associated with the media program changes, the view from the windows will also change. For example, if part of an movie takes place in NYC, the view from the windows may be of Manhattan. If the setting later changes to another city, or environment such as mountains, the view from the windows may change to a view of that other city or of mountains.

The virtual environment may be equipped with a variety of user-selectable seating options. In this way the user may select seating options for the virtual environment that are present in the user's real world environment thereby creating a more immersive experience for the user.

The user(s) may be represented in the virtual environment by an avatar such that the user's avatar is seated on the same seating element that the user is seated on in real life. Users may control their avatars by any means known to those skilled in the art, including but not limited to keyboard controls, or joystick controls (such as game pads or the Razor Hydra™). Motion capture control schema such as those enabled by motion capture devices like the Microsoft Kinect system or the LEAP Motion system may augment or replace manual control means and/or serve as an aid to rendering the user's avatar in the virtual environment.

Specific media types contemplated include Audio media such as music and audio books, video media such as movies and television programs (collectively “A/V media”). Text based media such as e-books are also be presented in some embodiments.

The media file may be any computer readable digital or audio file format known to those having skill in the art or later invented. The media file may be augmented to include metadata such as VE function tags by a process known in the art as “tagging” in which supplemental information or, “metadata” is added to the media file. With respect to audio files this may be known as ID3 tagging.

In order to increase immersion and enjoyment of a user, the media file may be tagged with VE function tags such as general attribute tags, setting and/or thematic tags. This could be done, for example, by tagging the media program with location information based on the time of the program. For example in a given audio book or video program, the first hour may take place in setting “A” or be associated with thematic element “1”, hour 2 through hour 4 may take place in setting “B” or be associated with thematic element “2” and the like. Additional data may be encoded by the tags, with no limit on the detail to be included. For example, time of day, weather, number of persons present, type of room, and the like. The VR rendering program recognizes the VEFTs containing the setting information and alters the virtual environment accordingly.

For example, a media program may include encoding for a plurality of virtual environments encoded in a computer readable medium wherein each setting change is associated with a VEFT. The computer used to render the virtual environment and play the media program will detect the VEFTs and render the virtual environment (selected from a plurality of virtual environments provided with the media program or created for the media program) associated with the relevant VEFT. As the media program progresses, the VEFT notifies the rendering computer to alter the virtual environment.

Various producers of media content may design VEs to correspond to their productions. For example the producer of an audio book, television, or movie program may design a virtual environment to correspond to setting and/or thematic elements of their production.

In the case where the media program being presented is audio media, the audio program in the virtual environment may be presented by an agent at the preference of a user. The agent can be anthropomorphic or non-anthropomorphic in different embodiments. A non-anthropomorphic agent is any representation of an audio source placed within the virtual environment. In some embodiments the non-anthropomorphic agent is linked to the output signal from the audio and alters its appearance based on the output signal (graphic equalizer). For example, the non-anthropomorphic agent will, throb, pulse or otherwise change form in response to the output levels from the audio. This may be accomplished by various methods known to those having skill in the art, such as, for example, by using tools such as the Visualizer Studio Pro Unity plug-in, from Altered Reality Entertainment. Visualizer Studio is a Unity Scripting Package which enables a developer to allow their game to react to music and sound effects. For example, the agent may take the appearance of glowing ball of light which will expand and contract or pulsate, or change colors based on the output levels of the audio program. In another example, the agent may be incorporated into an element of the virtual environment as in, for example a chandelier or a fire in a fireplace. In these examples the lights on the chandelier or fire may pulse, or increase size, or increase luminosity in response to the output levels of the audio program. These are just examples, any appropriate element of the virtual environment, may be used. Those skilled in the art will recognize many ways to accomplish this effect.

An anthropomorphic agent takes the form of a human figure or animal figure adopting motions typically associated with humans. The movements of the figure may be operatively linked to the output signal from the audio program. For example, the mouth of the figure may move in response to changes in the output signal thereby imitating the figure speaking words. Hand or arm movements may also be linked to the output signal of the audio program as in for example by waving in response to changes in the signal. The anthropomorphic agent may be stationary or may move about, randomly, in a fixed or changing pattern, or according to a program.

It may be desirable to more accurately mimic the movements, including the facial expressions of an anthropomorphic agent than can be currently achieved by linking said movements to the output signal of the audio program or by other programming methods. Therefore in other embodiments, motion capture methods are used capture the movements, including the facial expressions of a performer, while recording the audio program, and encode those movements in a computer readable medium. Later, the encoding is mapped onto the anthropomorphic agent in the virtual environment. The motion capture of the storyteller may be accomplished with any materials and methods known to those skilled in the well developed art of motion capture. For audio programs that are already recorded, it may be desirable to have someone “act out” the already recorded program in order to capture the motions associated with the program.

In embodiments an anthropomorphic agent is mapped to a networked performer such that the performer can present the audio content in real time. In this way a person can tell a story or otherwise perform to a group of people present in the VE.

In the case where the media presented is video media, the presentation agent is a screen.

Throughout this application various example locations and environments are described in order to illustrate the aspects of the invention. These examples should in no way be interpreted as limiting the available content of the virtual environments. The virtual environments contemplated may be any rendered to contain any content and will be limited only by the imagination of users, programmers or designers.

An embodiment is a virtual environment adapted for presenting media content to at least one user. In embodiments A/V media is presented. In other embodiments text based media is presented. The VE adapted for presenting media content to at least one user may be a bespoke VE specifically tailored to a given work of media content, or a VE template with variable elements that can be customized for various works. In various embodiments the VE further comprises a user interface for controlling media playback. The VE is rendered by a rendering engine associated with a computer. In embodiments the VE further comprises a plurality of attributes, the attributes may further comprise a plurality of attribute states. The rendering engine may be in communication with a media file, the media file further comprising VE function tags. The rendering engine alters the VE in response to detecting an VEFTs. As an example of a VE template, a VE may be constructed with a plurality of placeholder regions. A database that contains assets capable of being placed in the placeholder regions is in communication with the rendering engine that renders the VE. Upon detecting a VEFT, the rendering engine will query the database for effects/assets associated with that VEFT and fill a placeholder with the effect/asset associated with that VEFT's data. Alternatively the data (assets or effects) associated with the VEFTs may be included in the media file.

An embodiment is a computer readable file adapted for being presented in a VE. The computer readable file further comprising VEFTs including, setting tags, accent tags and/or motion capture data of a presenter/performer of the audio content. The media file being controlled from a user interface within a virtual environment. The rendering engine that renders the VE is in communication with the computer readable file and detects the VEFTs and alters the VE in response to detecting the VEFTs. The VEFTs are associated with assets/effects to be displayed in the VE. The assets/effects can be stored in a database that is part of the computer readable file or in a database remote from the computer readable file.

An embodiment is a method for coding a media program for presentation in a VE comprising the steps of tagging the audio content with VEFTs, including general attribute tags, setting tags, accent tags and/or motion capture data of a present/performer of the media content. In an embodiment of the method a coder is provided with an interface capable of controlling the playback of a media file and tagging the media file with various VEFTs, either as a function time of the media program or as a function of general information about the media program.

Another embodiment is a system for coding a media program for presentation in a VE. The system comprising a means for playing a media program to a listener, a means for allowing the listener to input VEFTs. A means for inputting VEFTs as a function of position of the media content. The system may further comprise a means for recording an audio program by a performer/presenter and/or a means of motion capturing the movements of the performer/presenter.

Another embodiment is a system for presenting media content in a virtual environment. The system comprises a computer readable media file, a virtual environment with dynamic attributes, and information relevant to altering the virtual environment to match substantive elements of the media program.

Another embodiment is a database containing information on a plurality of media programs where the information is capable of being communicated to a rendering engine that renders a virtual environment so that the rendering of the virtual environment can be altered in accordance with the information contained in the database. The database may comprise various fields as in, for example, title of the work, particular version, VEFTs including, general attributes, setting tags as function of time, accent tags as a function of time and motion capture data of a performer performing an audio program. The database may also contain data sufficient to render a VE or attribute(s) thereof. In this way a user may enjoy consumption of an media program in a VE without having to acquire additional versions of the media program.

In another embodiment the invention is a method of presenting didactic media content in a virtual environment. The method comprising the steps of tagging the media content with VEFTs including, general attribute tags, setting tags, accent tags and/or motion capture data of a present/performer of audio content. The didactic media content may also be tagged with figure tags which cause the virtual environment to display visuals adapted to aid in the presentation of the didactic material. Didactic material should be construed broadly as any material a user wishes to learn and/or remember. Didactic material associated with formal education is particularly contemplated. By way of non limiting example, the subject of science. An audio program of a science lecture may be recorded. The audio program could then be coded, as previously described herein. An additional element that may be desirable in the presentation of didactic material is the inclusion of visuals to aid in the teaching of the material. Towards this end VEFTs, encoding visual tags may be encoded in association with the recorded audio material. The visual tags communicate with the rendering engine and signal the rendering engine to display a given visual in the VE. Data encoding the visuals may be stored as part of the audio file or in a separate database. If the lecture in covers neuroscience, for example, and the lecture is describing the various parts of a neuron, a 3D model of a neuron could be displayed in the VE. Because the visual may be rendered in 3d in the VE, the user would be able to manipulate the visual, as in for example enlarging it, or rotating it to explore it further. Data encoding visuals to be presented in the VE may be stored in a database and the data imported, or caused to be displayed in the VE in response to a visual tag. This method would be particularly useful for distance learning programs and on-demand learning programs.

In another embodiment the invention is a method for improving retention of didactic material in a user. The method comprises presenting didactic information to a user in a virtual environment where the VE takes on distinct attributes associated with particular didactic material so that the user associates the particular didactic material with the distinct attributes of the virtual environment. It is a well known phenomenon that when a person is trying to remember something, a change in the person's environment can be a useful tool to enhance memory formation. For example, if a child is having a difficult time remembering the definition of the word “loquacious” a teacher may suggest reading the definition of the word in a unique environment, such as the bathroom. That way, when the child is trying to remember the word in the future, the child will say to herself: “this is the word I studied in the bathroom.” Virtual environments lend themselves particularly well to this type of memory augmentation as the virtual environments are capable of changing in an infinite variety of ways. In order to take advantage of the characteristics of VEs, particular subjects or parts of subjects that a user is having difficulty learning may be identified. This can be accomplished by manually inputting or identifying subjects that a user is having difficulty with. A user may do this his or herself or a teacher or other third party with knowledge of the user's difficulties may input this information. Alternatively, the VE program may be equipped to automatically detect subjects a user is having difficulty with. This can be accomplished by equipping the VE with a testing program that assesses a user's proficiency in a given subject. This would allow the program to identify the areas a user is struggling with based on the performance in the tests. Once the subject areas with which a user needs additional help with are identified, the VE can present the didactic material associated with those subjects again while altering the VE in a distinct way associated with that subject. The alteration of the VE may be related or unrelated to the particular subject matter. Using the same example, as above, a student may be presented with a vocabulary quiz in a VE. If the user fails to input the correct definition of “loquacious” the VE didact program would present the user with a unique environment while presenting the definition of “loquacious.” The unique environment in this example may be a unique room with a distinct wallpaper or soundscape (unrelated VE) or a room full of people talking (related VE).

In another embodiment the invention is a method for presenting text to a user in a virtual environment where attributes of the virtual environment change in response to substantive elements of the material conveyed by the text. A user may read in a virtual environment. This can currently be accomplished through a variety of methods, as in, for example by presenting the user with text. Text may be presented in a number of ways such as on a virtual surface projected (placed, depicted) in the user's field of view. In addition mixed real world/virtual world augmented reality systems and methods may be incorporated. For example, a user could hold a mixed reality tablet in his hands, elements on the tablet would enable the tablet to be represented in the virtual environment. The rendering engine could then place text or other visual media on the tablet in the VE thereby increasing the immersive nature of the experience. In order to create a more immersive and enjoyable reading experience, attributes of the virtual environment may change in response to occurrences in the textual material the user is reading. This can be accomplished by tagging the text file with VEFTs including setting tags that signal the virtual environment to change at certain positions in the text file. In order to more accurately alter the virtual environment in accordance with the reader's position in the text file, it may be desirable to estimate the reader's position in the text. For example, the setting of a story may change 50 lines into a 100 line page of text. To render the VE in accordance with that change the average reading speed of a user may be calculated by measuring the time the reader spends on each unit of text. Units may be pages (in a paginated e-book) or any other unit with which text is presented. Based on the average time per text unit the reader spends, a program estimates a reader's current position on a given page at any given time, and use that information to render the VE. For example if text is presented in 100 line pages and the reader advances pages, on average, every 1000 seconds, the average time it takes that reader to read one line of text is 10 seconds. Therefore, if the setting of a story presented in an e-book changes on line 60 of a given page, the rendering engine would alter the VE 600 seconds after the reader has advanced to that given page. In other embodiments, users' gaze or eye position may be tracked using eye tracking technology known to those having skill in the art, to indicate the user's position. The user's place in the text may be inferred from his or her eye position and the VE is altered accordingly.

The VE provides a 3D VE that includes images, 3D assets, animations, scenery, and content that is related to substantive elements of a media program. A user accesses the VE from their computer by any method known to those skilled in the art, for example, by a local client or over a packet network. Interaction between users and the VE environment or between users in the VE is facilitated by avatars, which are characters that represent the users. Users in the VE have their own avatar and may customize its appearance to their choosing. Movements and interaction of an avatar in the VE are controlled by users by using any input/output devices known to those skilled in the art. Motion capture devices such as the Razor Hydra®, Microsoft Kinect® and the LEAP Motion® sensor are particularly useful. The VE may be implemented as one or more instances, each of which may be hosted locally or by one or more VE servers. Avatars representing users may move about in the VE and interact with objects or each other. VE servers which may be run locally on users' computing devices maintain the VE and generate a visual presentation for users based on the user's avatar within the VE. The view may also depend on the direction the avatar faces and a selected viewing option (1st person, 3rd person, etc). The computing device runs a VE client and provides a user interface to the VE engine. The 3D engine renders the VE. A database contains information related to substantive elements of a media program. This information may be incorporated into the VE such that it will alter attributes of the VE in relation to substantive elements of the media program. The 3D engine may include a processor which can create a 3D VE, determine if changes are to be made to the VE, load data from the database or the augmented media file, into the VE. The processor need not be within the 3D engine but can be situated remotely and in communication with the engine. The 3D engine may include a virtual template selector which creates a 3D VE template based on substantive elements of the audio program.

Each user has a computing device that may be used to access the multi dimensional computer generated VE. The VE client within the computing device may be a stand alone software application or be a thin client that simply requires the use of an internet browser an optional plug-in. A separate VE client may be required for each VE a user wishes to access, although a particular VE client may be designed to interface with multiple VE servers. The VE client may also enable users to communicate with other users who are present in the VE. The communication portion of the client may be a separate process running a user interface.

Computing device, virtual environment servers and communication servers each include CPUs, memory, volatile/non-volatile storage, communication interfaces and hardware and software peripherals to enable each to communicate with each other across network and to perform the functions described herein.

The user sees a representation of a portion of the multi-dimensional computer-generated virtual environment on a head mounted display and input commands via a user input device such as a mouse, touch pad, or keyboard. In embodiments A head mounted display is used by the user to transmit/receive audio information while engaged in the virtual environment. For example, display is a head mounted display that displays an immersive VE to the user and may include an integrated speaker and microphone. Separate headphones, speakers and/or microphone may also be used. The user interface generates the output shown on display under the control of virtual environment client, receives the input from the user via user input device and passes the user input to the virtual environment client. Virtual environment client passes the user input to virtual environment server which causes the user's avatar or other object under the control of the user to execute the desired action in the virtual environment. In this way, the user may control a portion of the virtual environment, such as the person's avatar or other objects in contact with the avatar, to change the virtual environment.

It is determined whether an VEFT such as an attribute tag is encountered while playing the media file. This determination is typically based on data provided in the media file or accessed in a database. If it is determined that a tag is encountered, the virtual environment will be altered in a predetermined fashion in accordance with the VEFT. The predetermined alteration of the VE may be encoded in the code used to build the VE or be present as part of the media file, or part of a database. The 3D template VE or VE may include placeholders that can contain information related to VEFTS. For example, the template and parameters can create spaces such as virtual rooms, desks, furniture, walls, and other objects where information related to the VEFTS encountered while playing the media program can be displayed. The template may also include 3D areas where 3D objects related to each VEFT is placed.

The database stores information according to specific VEFTs. This information is typically provided by any entity with sufficient familiarity with the media program and contains initial data related to the VEFT. Once a new VEFT has been identified, this information is accessed so that the virtual environment can be altered in accordance with the VEFT. Once the parameters and data have been loaded into the created 3D template, the 3D engine renders the virtual environment, and the media program can begin/continue.

Placeholders define a particular shape and surface and are sized and oriented within the 3D virtual environment such that they are later filled with assets related to the VEFT of interest. Placeholders map a data texture such as, for example, furniture, accent pieces, landscapes, visuals, 3D models, views from windows and the like into the 3D virtual environment in an initial location, size and shape defined by template. Placeholders may be of any shape such as a sphere or cube and can include all types of three dimensional shapes, compound shapes, vistas, spaces and the like.

In addition to placeholders, textures within the virtual environment are defined. Examples of textures are the lighting of the virtual environment world, e.g., brick or plaster walls, light from the sun or light from a florescent desk lamp or overhead skylight, etc. Whichever textures, placeholders and objects chosen for template are saved within database so that they can quickly be accessed to duplicate the virtual environment for users. Any updates to the textures that occur during the playback of the media program may be stored. Further, in some embodiments, placeholders are customized by allowing them to be moved, edited, and/or deleted to suit the user's needs. Additional placeholders may also be added to walls or other locations throughout the virtual environment. Thus, template may be customized in order to suit the user's needs or individual preferences.

An media program and a VE that can be synchronized may be referred to as VE-MP pair. For each pair, content synchronization information associated with the VE-MP pair can be generated, transmitted, and/or obtained via computing devices in a communication network. The content synchronization information can include any data related to the synchronous presentation of the media program and the VE, so as to enable one or more computing devices to synchronously alter the VE in relation to the media program. Content synchronization information can include reference points mapping portions of the media content to corresponding attributes of the VE. In a specific example, content synchronization information can include data that can be used to map a segment of the media program (e.g., a word, line, sentence, musical phrase, etc.) to an attribute in a VE. The content synchronization information can also include information related to the relative progress of the presentation, or a state of presentation of the digital representation of the content. The synchronous alteration of the VE can vary as a function of the capabilities and/or configuration of the device (e.g., resolution of the VE) and/or the formats of the content in a VE-MP pair. Accordingly, the content synchronization information can be generated in a variety of formats, versions, etc.

The audio program and the VE content in a VE-MP pair may be decoupled from each other, for example, by being stored on separate computing devices, by being stored in separate data stores that are not part of the same logical memory, by being obtained via different transactions, by being obtained at different times, by being obtained from different sources, or any combination thereof. For instance, a user can buy an audio book or television series and then at a later point in time purchase a VE in which to listen to the audio book or watch the television series, or purchase access to a database containing information sufficient to render a VE and alter the VE as a function of substantive elements of the audio or other media program.

With the VE, media program and the content synchronization information available to the same computing device, the computing device can synchronously alter the attributes of the VE as a function of substantive elements of the media program to provide the user with an enhanced content consumption experience. For instance, the user may listen to the audio book of Moby Dick while virtually sitting in a VE appointed with a nautical theme or otherwise enhanced to correspond to the playback of the audio book. The synchronous presentation experience may also include, for example, automatic alteration of the VE synchronized with audio playback such as, for example, changing the VE from one constructed to resemble a circa 1800s boarding house, to one constructed to resemble the deck of a whaling ship as the events in the audio book move from the land to the sea.

A portion of audio content that matches the attributes of the VE can be presented at one point in time. Then, at another point in time, a portion of the VE can be synchronously altered based on the presentation position of the audio content. The attributes of the VE can be continually updated based on the content synchronization information and the presentation position of the audio content.

In some embodiments, the synchronized content may be presented on the same computing device that records the narration audio content. In other embodiments, the synchronized content may be presented by a second computing device remote from the narrator's computing device.

As previously discussed, content synchronization information can include reference points mapping portions of the media content to corresponding attributes of the VE. For example, content synchronization information can include data that can be used to map a segment of media (e.g., a word, line, sentence, musical phrase, etc.) to a timestamp of the media recording. The content synchronization information can also include information related to the relative progress of the presentation, or a state of presentation of the media content such as a substantive element of the media content, as in, for example, a critical plot element, crescendo, or the like. The content synchronization information can be generated in a variety of formats or versions

VEFTs include general attribute tags assigned to a given media program. These general attribute tags relate to the work as a whole and do not vary as a function of time. For example if the media program is an audio book the general attribute tags may include the audio book's genre, such as horror, action-adventure, romance and the like, or may relate to a time period related to the work, such as “the future” or, stylistic elements such as gothic or the like. In some embodiments attribute tags are assigned to the media program that vary as a function of elapsed time of the media program. These time specific VEFTs further comprise setting tags and accent tags. Setting tags relate to changes in setting and tone in the media program as it progresses. For example, if the media program is an audio book the setting tags mirror the settings of the story being told in the audio book and change as the setting changes within the audio book. For example, if chapter 1 takes place on a beach, the appropriate setting tag would be coded for the position of the audio book that takes place on a beach. The rendering engine of the VE upon detecting this VEFT renders appropriate assets/effects associated with the tag, such as a view of the ocean or the like. If the setting later changes to the mountains, an appropriate VEFT is coded for those parts of the audio book that take place in the mountains and upon encountering this VEFT, the VE assets/effects change accordingly. In addition to setting tags, accent tags are coded as a function of time of the media program. Accent tags would not necessarily be associated with any setting changes related to the substance of the media program (although they may be), but would instead relate to other substantive elements of the media program. For example, if the media program is an audio book, the accent tags could relate to plot elements. For example the time where the killer in a mystery story is revealed is tagged with an accent tag, or a portion of the audio book associated with rising suspense may be tagged with an accent tag. Various accent tags are associated with assets/effects rendered in the VE that coincide with the detection of the accent tag. The events rendered in the VE in association with the accent tags could be any event appropriate to accent the substantive element in the media program for example, lightning and thunder, a bird landing nearby, change in lighting, raise in volume of background music or the like.

As creating bespoke virtual environments from scratch for each media program may be a cumbersome task it may be desirable to have a template virtual environment that could be used for the presentation of various media programs. Therefore, a template VE is provided. The VE template includes consistent elements and variable elements. The computer that renders the virtual environment is in communication with a database containing information about what assets/effects are displayed in the variable elements of the VE template.

While the coding of the media program may be done by the producers of the media program, it may be desirable to provide a coding interface for users so that they could code media programs to their liking. In such a way, users' various tastes and interpretations could be associated with various media programs and allow for a faster populating of data for use in the VE as well as differing versions of a VE for the same media program (“user generated content”). An example template may include an inside room with windows, a balcony overlooking scenery, and an outdoor area.

Turning now to the figures:

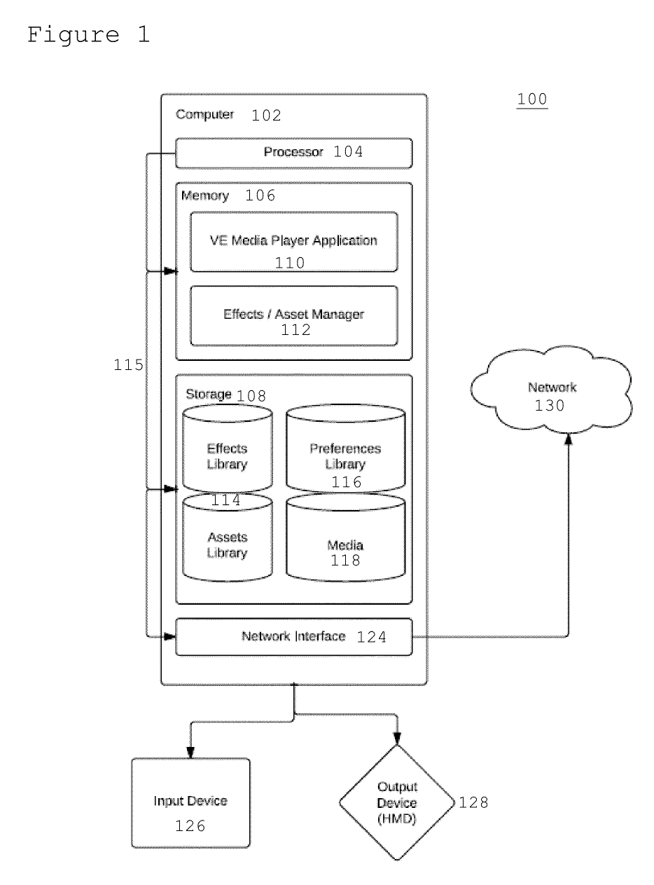

FIG. 1 is a block diagram illustrating a system 100 for presenting media in a virtual environment (“VE”), according to one embodiment disclosed herein. The system 100 includes a computer 102. In one embodiment, the computer 102 provides a rendering of the VE. The computer 102 is connected to a network 130, and may be connected to other computers via the network 130. In general, the network 130 may be a telecommunications network, a local area network (LAN), and/or a wide area network (WAN). In a particular embodiment, the network 130 is the Internet.

The computer 102 generally includes a processor 104 connected via a bus 115 to a memory 106, a network interface device 124, a storage 108, an input device 126, and an output device—Head Mounted Display 128. The processor 104 is included to be representative of a single CPU, multiple CPUs, a single CPU having multiple processing cores, and the like. Similarly, the memory 106 may be a random access memory. While the memory 106 is shown as a single identity, it should be understood that the memory 106 may comprise a plurality of modules, and that the memory 106 may exist at multiple levels, from high speed registers and caches to lower speed but larger DRAM chips. The network interface device 124 may be any type of network communications device allowing the computer 102 to communicate with other computers via the network 130.

The storage 108 may be a persistent storage device. Although the storage 108 is shown as a single unit, the storage 108 may be a combination of fixed and/or removable storage devices, such as fixed disc drives, solid state drives, floppy disc drives, tape drives, removable memory cards or optical storage. The memory 106 and the storage 108 may be part of one virtual address space spanning multiple primary and secondary storage devices.

The input device 126 may be any device for providing input to the computer 102. For example, a keyboard and/or a mouse may be used. In some embodiments, the computer 102 is a mobile device coupled to a head mounting adaptor or a free standing VR/AR HMD, which has control buttons and other input devices 126 directly on its surface. The output device 128 may be any device for providing an immersive VE to a user of the computer 102. For example, the output device 128 may be any virtual reality or augmented reality head mounted displays with their associated speakers/earphones. Although shown separately from the input device 126, the output device 128 and input device 126 may be combined. For example, a HMD with an integrated touch-screen may be used.

As shown, the memory 106 of the computer 102 includes VE media player application 110. The VE media player application 110 is a general purpose application which in some embodiments may provide the operating system of the computer 102 and controls its overall functionality. In some embodiments, the VE media player application 110 is the application which presents a media program and a VE to a user using the computer 102. Also shown in the memory 106 is the effects/asset manager 112. The effects/asset manager 112 is an application configured to output additional effects through the computer 102 to enhance a user's media experience. In some embodiments, the effects manager 112 is a component of the VE media player application 110.

As shown, the storage 108 contains an effects/assets library 114. The effects/assets library 114 is a repository for effects and assets, the format of which includes, but is not limited to audio, temperature changes, wind, vibration, and smells, 3D models, animations, and the like. The effects library 114, for each effect, may also store contextual and other associated data used to identify proper points at which to output the effects. As shown, the storage 108 also contains a preferences library 116. The preferences library 116 is used to store preferences of users of the computer 102. In some embodiments, the user data stored in the preferences library 116 may be for local users of the computer 102. In some embodiments, user data from other users may be stored on in the preferences library 116, and may include user data from the Internet. As shown, the storage 108 also contains media files 118. The media 118 is a repository for the media stored on the computer 102. Although depicted as a database, the effects/assets library 114, preferences library 116, and media 118 may take any format sufficient to store data. Although depicted as part of the computer 102, the effects/assets library 114, preferences library 116, and media 218 may be stored at a remote location and later accessed by the effects/asset manager 112. In some embodiments, the effects/assets library 114 may offer additional effects and or assets which are available for purchase. In these embodiments, a user of the computer may decide to block the purchase of any such effects/assets, choosing only royalty-free effects or assets. In some embodiments, a publisher of the media may include its own effects/assets which are stored in the effects/assets library 114, and may configure the effects/assets such that they may or may not be overridden by the user, depending on the service level agreement. In some embodiments, a user may generate his or her own effects/assets, save them to the effects/assets library 114, and share them with other users on the Internet.

In some embodiments the computer may be or be connected to a VE function tag (VEFT) server. The VEFT server analyzes portions of media identified in requests to identify VEFTs contained therein or associated therewith. The VEFT server also analyzes the media to identify the effects/assets associated with the VEFTs. The VEFT server, which may be integrated in the computer, the media files, or an external database, provides the VEFTs in response to requests.

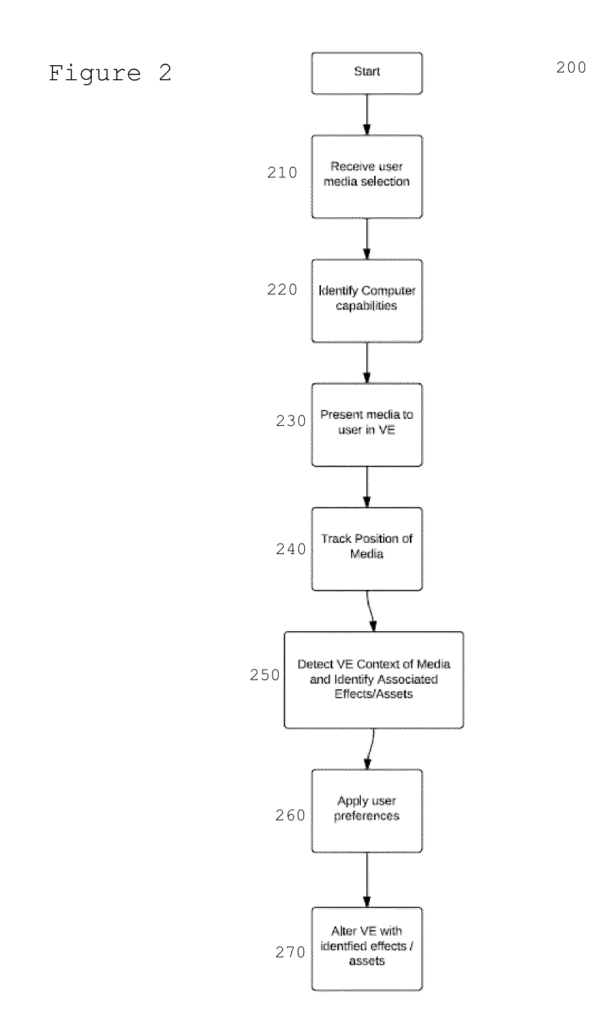

FIG. 2 is a flow chart depicting a method 200 for presenting media to a user in a virtual environment, according to one embodiment disclosed herein. It should be recognized by one of ordinary skill in the art that the particular order of steps in the method 200 is just one embodiment, and any suitable order may be used to implement the functionality of the method 200. At step 210, the VE medial player application 210 receives a user selection of a media program. In some embodiments, a user may select an media program from the media 118, or may obtain an media program from an online source. At step 220, the capabilities of the computer being used by the user are identified. In some embodiments, the effects/assets manager 112 makes this determination. In identifying the capabilities of the user's computer, the effects/assets manager 112 may determine what additional effects may be outputted to the user based on the hardware the computer contains. For example, if the computer does not have a powerful graphics card, the graphics of the VE can be turned down to accommodate the processing capabilities of the computer. The effects/assets manager 112 identifies a set of preferences. The preferences are related to the user of the computer, but may also include the preferences of other users. The preferences may include, for example, a user's desire to disable all temperature effects, or limit audio effects to a certain specified class of audio (e.g., weather effects, spoken text, ambient noise, soundtracks). The preferences may also relate to a particular type of media, for example, a user may choose to not play sound effects for video files with their own audio. At step 230, the VE media player application 110 presents the media in the VE on the user's HMD.

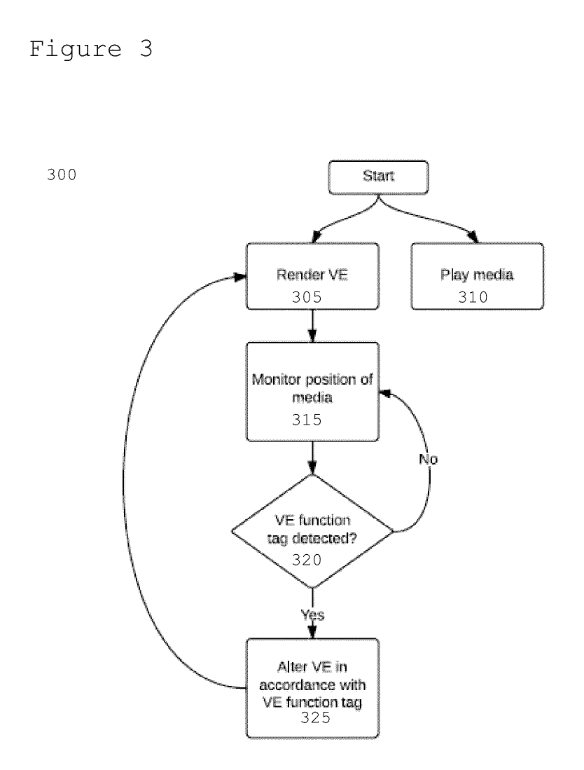

At step 240, described in greater detail with reference to FIG. 3, the effects/assets manager 112 tracks the position of the media. The position may be based on the current elapsed time in the media, or by using eye tracking techniques if the computer/system is so enabled, and the media being presented is textual media. At step 250, the effects/assets manager 112 determines a context within the media and identifies effects/assets associated with the context. For example, if the effects/assets manager encounters a VEFT indicating a setting of woods at night, assets/effects may be played which have been associated with night time woodland environments. Thus, a 3D woodland environment including tree assets, terrain assets, and the like as well as, sounds of owls hooting, bats flying, and wind rustling through leaves may be rendered in the VE. At step 260, the effects/assets manager applies the identified preferences to the identified effects/assets. If the preferences override an identified effect, the identified effect/asset is not output by the effects/assets manager 112. The effects/assets manager 112, in applying preferences, takes a number of factors into account, including context, user preferences, and online preferences. For example, although a particular sound may be associated with a specific context, the user may have overridden the sound with a different sound, and the custom sound will be played. At step 270, the effects/assets manager 112 outputs effects/assets to the user through the computer hardware and alters the VE with the identified effects/assets.

FIG. 3 is a flow chart depicting a method 300 for altering the VE in accordance with substantive elements of the media program as mediated by VEFTs, according to one embodiment disclosed herein. In some embodiments, the effects/assets manager 112 executes the steps of the method 300. At step 305, the effects manager executes a loop including steps 305-325 while the user is consuming media in the VE. At step 315, the effects/assets manager 112 determines the current position of the media. This provides an initial starting point for the effects manager 112 to begin monitoring for VEFTs. At step 320, the effects/assets manager 112 determines whether a VEFT is detected. This determination may be made by referencing the information in a database or integrated into the media file being played. If a VEFT is detected the effects/assets manager will cause the VE rendering to alter in response to the VEFT, 325 such as, for example, by changing the time of day in the VE or progressing from one VE to another. If no VEFT is detected, the effects/assets manager will continue to monitor the position of the media, 315.

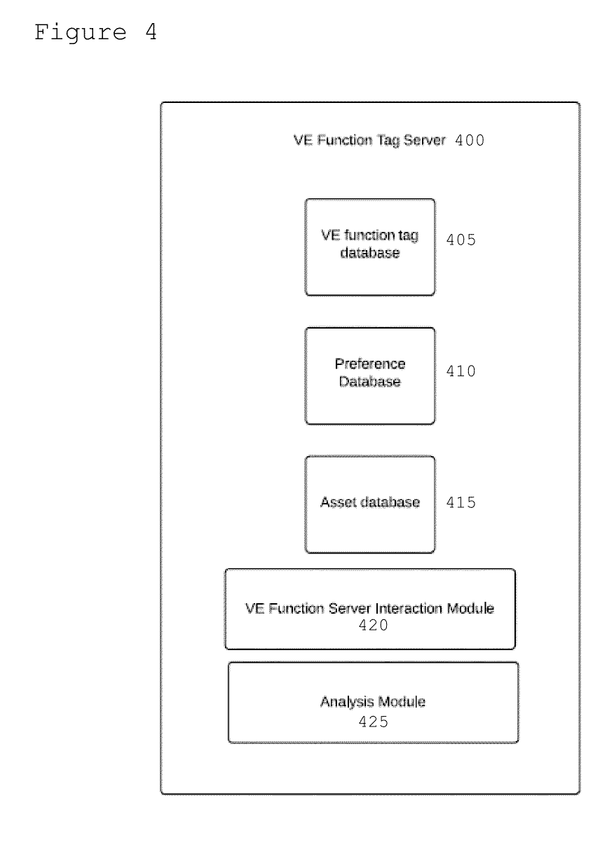

FIG. 4 is a high-level block diagram illustrating a detailed view of the VE Function Tag (VEFT) server 400 according to one embodiment. As shown in FIG. 4, multiple modules and databases are included within the VEFT server 400. In some embodiments, the functions are distributed among the modules, and the data among the databases, in a different manner than described herein. Moreover, the functions are performed, or data are stored, by other entities in some embodiments, such as by the computer 102 or effects/assets library 114.

A VEFT database 405 is a data store that stores VEFT information for multiple media files. In one embodiment, each of the plurality of media files is identified using a unique identifier (ID), and the VEFT information is associated with a particular media file using the media file IDs. A single media file may have many VEFTs. As mentioned above, the VEFT information for a particular VEFT includes location information specifying a location of the VEFT in the media file and VE alteration information describing how to alter the VE at the VEFT. For example, the VEFT information may indicate that a particular VEFT is located at a particular playback location in an audio or video media file.

The VE effect/asset information may associate a specific alteration of the VE with a VEFT, such that the associated alteration is executed when a media file reaches the time-stamp associated with the VEFT. For example, the asset/effect information may associate a visual effect such as lightening flash, with VEFT. Alternatively, the VE effect/asset information may associate a asset/effect type with a VEFT. The effect/asset type indicates the general type of VE alteration to execute at a VEFT. For example, the VE effect/asset type may indicate to alter the weather in the VE, and/or a particular type of weather effect at a VEFT, without indicating the exact alteration to make.

A preference database 410 is a data store that stores preferences for users of the computer or system 102 with respect to VE effect/asset selection. These preferences may be explicitly provided by the users and/or inferred from user actions.

An effect/asset database 415 is a data store that stores effects and assets that may be associated with VEFTs and used to affect an alteration to the VE. Depending upon the embodiment, the effect/asset database 415 may store data files storing the assets/effects or asset/effect IDs referencing assets and effects stored elsewhere (e.g., URLs specifying locations of asset, animation, sound, 3D models of environments, video files on the network 130). For each effect/asset, the effect/asset database 415 may also store metadata describing the effect/asset.

A VEFT server interaction module 420 receives VEFT requests from the computer 102 and provides corresponding VEFT information in response thereto. Additionally, the VEFT server interaction module 415 may receive preference reports from the computer 102 indicating user preferences and update the preference database 410. A VEFT request from a user's computer 102 may include a media ID identifying the media for which the VEFTs are being requested, a start point identifying the starting point in the media for which VEFTs are being requested, an end point identifying the ending point in the media for which VEFTs are being requested, and a user ID identifying the user. The VEFT server interaction module 420 uses the VEFT request to identify the section of a media file bounded by the start and end points for which VEFT information is requested. In addition, the VEFT server interaction module 420 uses the user ID to identify user preferences stored in the preference database 410. The VEFT server interaction module 420 provides this information to other modules within the VEFT server 400 and receives VEFT information in return. The VEFT server interaction module 420 then provides this VEFT information to the requesting computer 102.

An analysis module 425 analyzes the VEFT requests to identify corresponding VEFT information. Specifically, for a given VEFT request identifying a section of a media file, the analysis module 425 identifies the location information for VEFTs within that section. To determine the location information, the analysis module 425 accesses the VEFT database 405 for the identified media file. The VEFT locations in a media file may be explicitly specified in the file by the author, publisher or another party. In this case, the analysis module 425 accesses the VEFT database 405 to identify the explicit VEFTs within the section of the media file.

The analysis module 425 also identifies the VE effect/asset information for identified VEFT within the section of the media. As mentioned above, the VE effect/asset information for an explicit VEFT may indicate a specific effect/asset or a effect/asset type to execute at the VEFT. In one embodiment, if the effect/asset information indicates a type of effect/asset to execute, the analysis module 425 analyzes the effect/asset information in combination with the available effects/assets in the effect/assets database 415 and/or user preferences in the preference database 410 to select a specific effect/asset having the effect/asset type to associate with the VEFT.

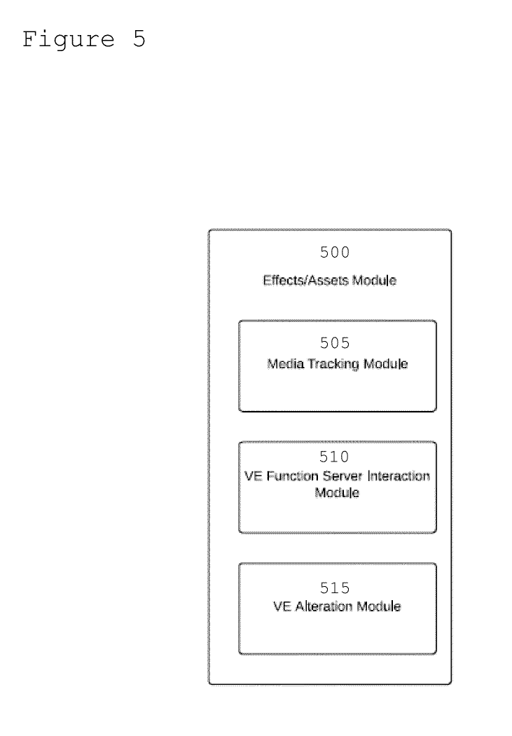

FIG. 5 is a high-level block diagram illustrating a detailed view of the Effects/Assets module according to one embodiment. As shown in FIG. 5, multiple modules are included within the effects/assets module 500. In some embodiments, the functions are distributed among the modules in a different manner than described herein. Moreover, the functions are performed by other entities in some embodiments.

A media tracking module 505 calculates the position of media being presented in the VE. This calculation may be accomplished through methods including eye tracking, in the case of textual media, and time interval measurement in the case of A/V media. For example, sensors on the user's computer system, specifically the users HMD 128 may track the eyes of the user to locate where in the text the user is looking.

A VE function server interaction module 510 sends VEFT requests to the VEFT server 400. In one embodiment, the interaction module 510 determines a section of media for which VEFT information is needed, and sends a VEFT request for that section to the VEFT server 400. The section of media may be, e.g., a subsequent section about to be played/presented by the computer, a subsequent chapter of an audio book, a next scene in a video file, or even an entire media file. For example, if the user anticipates having a limited network connection when playing a media file, the user may instruct the interaction module 510 to retrieve and store all VEFT information and associated effects/assets for offline use.

In addition, the interaction module 510 may transmit user preference reports to the VEFT server 400. The interaction module 510 subsequently receives the requested VEFT information from the VEFT server 400.

A VE alteration module 515 alters the VE based on the position of the media being presented in the VE. In one embodiment, the VE alteration module 515 uses the media tracking module 505 to track the position of the media being presented. When the VE alteration module 515 detects that the user reaches the VEFT location, it executes the change to the VE associated with the VEFT, such as for example, by changing the weather in the VE, changing the time of day, playing a sound effect, or the like. The VE alteration module 515 may use the information in the VEFT information, as well as user preferences, to decide how and when to alter the VE.

To effect a change in the VE or execute an effect, an embodiment of the VE alteration module 515 uses the asset/effect information to retrieve the asset/effect from the VEFT server 400 or elsewhere on the network 130. The VE alteration module 515 may retrieve the asset/effect prior to when the asset/effect is to be executed, such as when the user begins the presentation of the media, the section containing the VEFT, or at another time.

In one embodiment, the VE alteration module 515 identifies the asset/effect information for VEFTs, rather than this task being performed by the analysis module 425 of the VEFT server 400. In this embodiment, the VEFT information that the VEFT module receives from the VEFT server 400 indicates the type of asset/effect to execute. The VE alteration module 515 analyzes the asset/effect information in combination with assets/effects available to the VEFT module and/or user preferences to select a specific asset/effect. This embodiment may be used, for example, when the user preferences and/or assets/effects are stored at the user's computer 102.

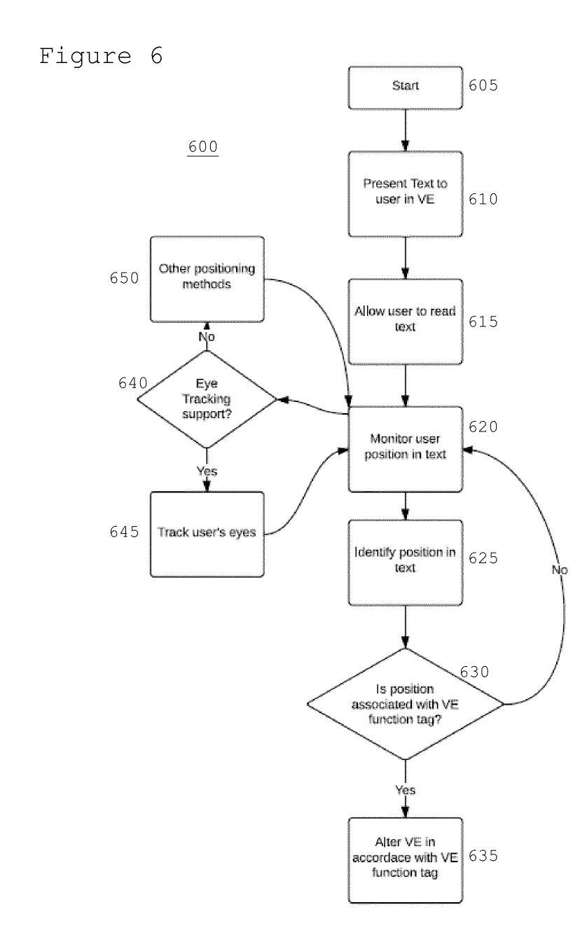

FIG. 6 is a flow chart depicting a method 600 for presenting textual media to a user in a virtual environment, according to one embodiment disclosed herein. It should be recognized by one of ordinary skill in the art that the particular order of steps in the method 600 is just one embodiment, and any suitable order may be used to implement the functionality of the method 600. At step 605 a user initiates the VE media player application which, in the case of textual media, presents text to the user in the VE 610. The user is allowed time to read the text that is presented 615. As the user reads, the user's position in the text is monitored 620. In monitoring the user's position in the text 620, the method includes the step of querying whether the users computer supports eye tracking 640, if eye tracking is supported, the method will track the user's eyes 645 to determine the user's position in the text. If eye tracking is not supported, other positioning methods, such as those previously described, are employed by the method 650. Whichever methods are used to monitor the user's position in the text 620, the method identifies the user's position in the text 625 and then queries whether that position is associated with a VEFT 630. If the position is associated with a VEFT, the VE is altered in the way indicated by the VEFT. If the position is not associated with a VEFT, the method returns to monitoring the user's position in the text 620.

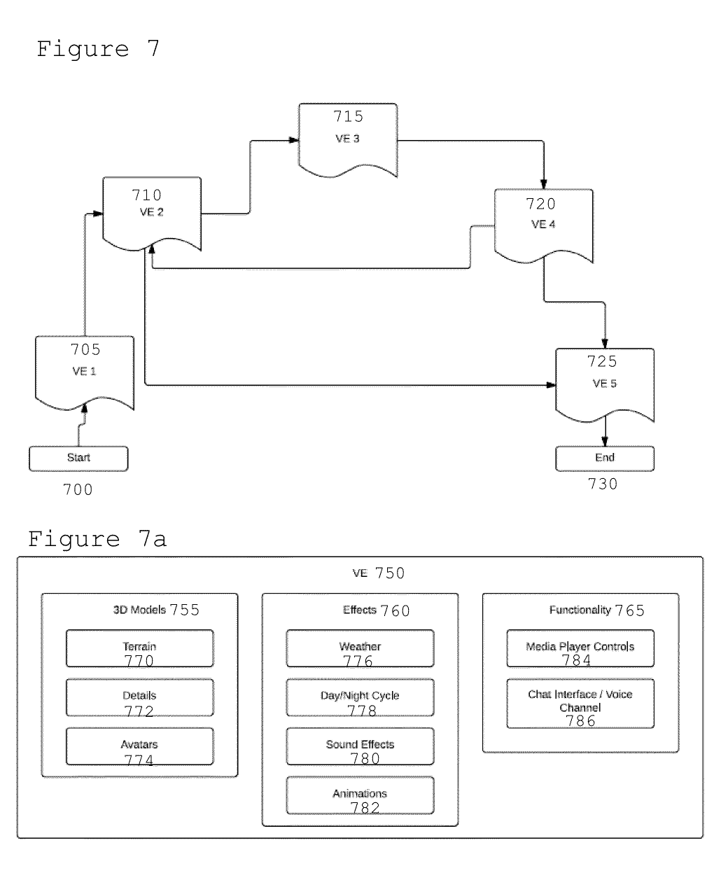

FIG. 7 is a high-level block diagram illustrating an exemplary manner in which various VEs are presented to a user during the presentation of media. For the sake of this example, the media being presented is an audio book, the story presented in the audio book takes place in 5 distinct settings, hereby denoted VE1-VE5. A users initiates play of the audio book media 700. The first chapter of the audio book takes place in a city in present day 705. As the audio book progresses to chapter 2, which takes place in the same city but 200 years ago, the VE alters from VE1 to VE2. Chapter 3 takes place in a forest setting, so as chapter 3 begins, the VE alters from VE2, 710 to VE3 715, a forest VE. Chapter 4 takes place in a desert, so as chapter 4 begins, the VE alters from VE 3, 715 to VE4, 720. Chapter 5 takes place in VE2, so as chapter 5 begins, the VE alters to VE2. Chapter 6 takes place in a city, in the future so as chapter 6 begins, the VE alters to VE5 725.

FIG. 7a is a high level block diagram illustrating the various elements that make up a VE. Those having skill in the art will recognize that additional elements may be added or some elements removed while still maintaining the concept of the VE. Generally speaking a VE 750 is made up of 3D models 755, effects 760 and functionality 765. The 3D models 755 that make up a VE generally include terrain assets 770, detail assets 772 and avatar assets 774. Terrain assets 770 include geographic and terrain models of large scale environments such as mountains, plains, water bodies and the like. Detail assets 772 include smaller detail model objects such as trees, rocks, boulders, buildings, vehicles, props and the like. Avatars 774 represent users and non player characters in the VE. VEs also include effects 760. Effects include weather 776, day night cycle 778, sound effects 780 such as ambient sounds, and animations 782. VEs also include functionality 765, such as a control interface for controlling media playback 784, and networked chat interface 786 such as voice or text chat. The presence or absence of various 3D models and effects are mediated through VEFTs and as further described above.

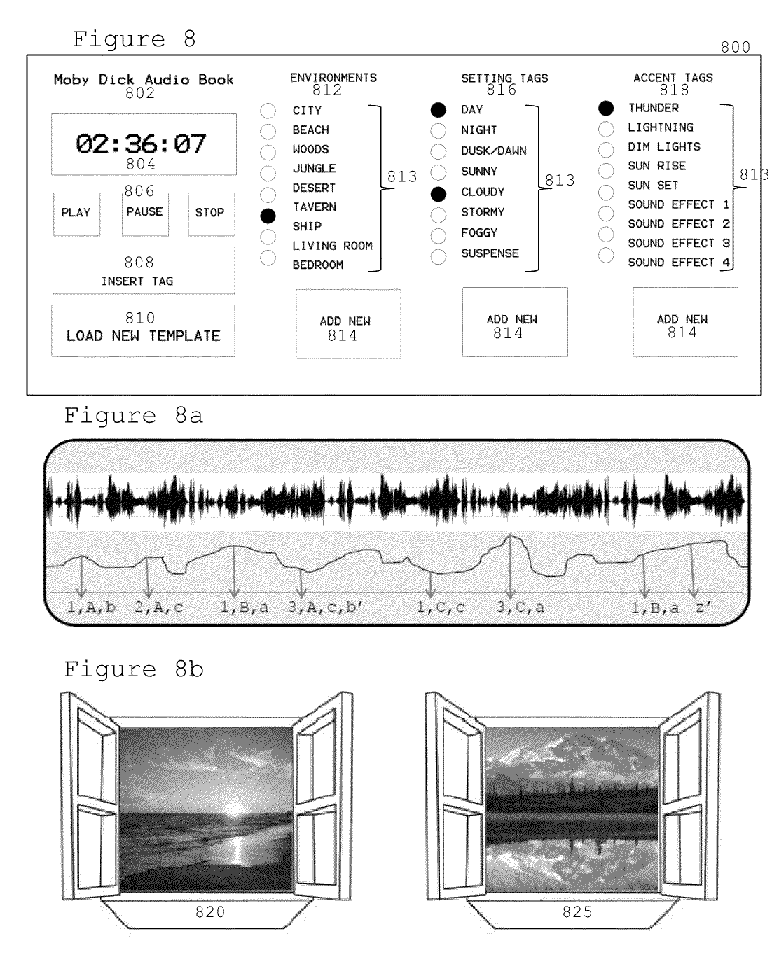

FIG. 8 shows an example of a user interface (“UI”) for a method of coding VEFTs to be associated with a media file. Once coded, the VEFTs can be inserted into the media file, or exported as a stand-alone file, such as an XML file, for later association with the media file. The functions of the method for coding a media program for consumption in a VE are illustrated by the elements of the UI. A media file to be coded is loaded into the coding program and appears in the media ID window of the UI 802. A VE template containing various environments and attributes is loaded into the program 810. Using the playback controls 806, the coder initiates playback of the media file to begin the coding process. Once the initial setting elements of the media are observed by the coder, the coder can go back and set the initial conditions to be presented to a user when the media begins playing. As the media progresses, the coder will observe information about substantive elements of the media program and encode them as attributes in the VE through the UI. In order to encode those elements, the coder will insert a VEFT by selecting the insert tag option on the UI 808. Once the insert tag option has been selected, the media playback will pause allowing the user to enter the substantive information about the media into the UI. Exemplary substantive information that is entered about the media is the type of environment 812 at the current position of the media, setting 816 information about the current position of the media, and plot elements indicated by accent tag 818 information at the current position of the media. Various states 813 for each attribute are also selected by the coder. If the states provided by the template are insufficient to encode the substantive information about the media, new attributes or states can be added using the add new 814 option on the UI. Once the coding is complete the VEFTs can be inserted into the media file or exported as stand-alone file for later association with the media file.

FIG. 8a shows a schematic representation of a media file with VEFTs inserted therein. In this example Numbers signify environment (location), capital letters signify weather, lower case letters signify thematic elements and lower case prime letters indicate accent tags.

FIG. 8b illustrates how a view from windows in a VE change as the computer rendering the VE encounters VEFTs. A computer rendering a VE comprising windows which overlook an environment detects VEFTs as coded with the method described above. The computer detects a VEFT indicating a beach environment, and the computer renders a beach environment by loading the assets/effects associated with the beach environment into the VE which is viewable through the windows in the VE 820. Later, when the computer rendering the VE detects a VEFT indicating a mountain environment, the assets/effects associated with the mountain environment are loaded into the VE and are viewable through the windows of the VE 825.

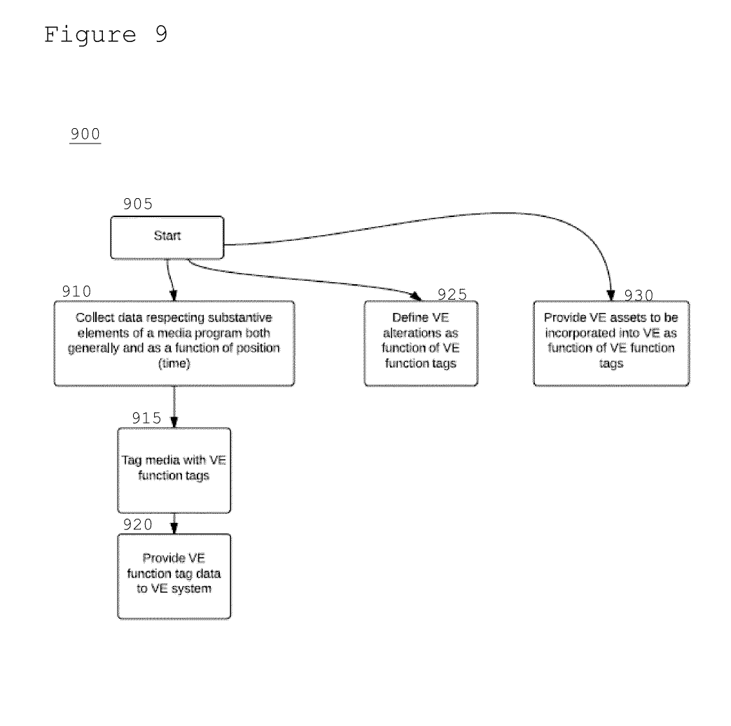

FIG. 9 is a flow chart depicting the overall method 900 for presenting media to a user in a virtual environment, according to one embodiment disclosed herein. It should be recognized by one of ordinary skill in the art that the particular order of steps in the method 900 is just one embodiment, and any suitable order may be used to implement the functionality of the method 900. The method begins at step 905 wherein a selection is made regarding the media to be presented in the VE. Once the media is selected data is collected about substantive elements of the selected media 910. The collected data is encoded by tagging the media with VEFTs 915 as described above. The media and the media's associated tags are then provided to a computer 920 that will play the media and render the associated VE.

Information is provided to the computer playing the media and rendering the VE about how to alter the VE in response to detecting a VEFT. This is done by defining VE alterations as a function of VEFTs 925. In order to give the computer the materials it needs to render the VE appropriately in response to VEFTs, the computer is provided with assets/effects to be incorporated into the VE in response to detecting VEFTs 930.

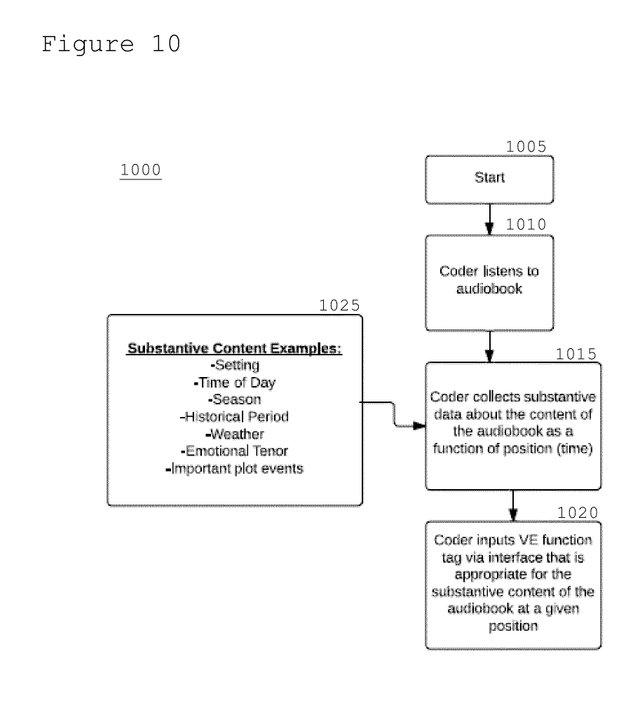

FIG. 10 is a flow chart depicting the method 1000 for coding media to be presented to a user in a virtual environment, according to one embodiment disclosed herein. In this particular example an audio book is selected as the media to be encoded and presented. It should be recognized by one of ordinary skill in the art that the particular order of steps in the method 1000 is just one embodiment, and any suitable order may be used to implement the functionality of the method 1000. The method begins by selecting the media to be encoded for presentation in a VE 1005. A coder then listens (in the case of audio media) or watches and listens (in the case of video media) to the media 1010. As the coder listens and or watches, the coder collects substantive data about the content of the media as a function of time 1015. Examples of substantive data about the media include but are not limited to those examples shown at 1025, namely: setting, time of day, season, historical period, weather, emotional tenor, and important plot events. Once the coder has collected the substantive data, the coder inputs that data 1020 as VEFTs via a UI as described in more detail above.

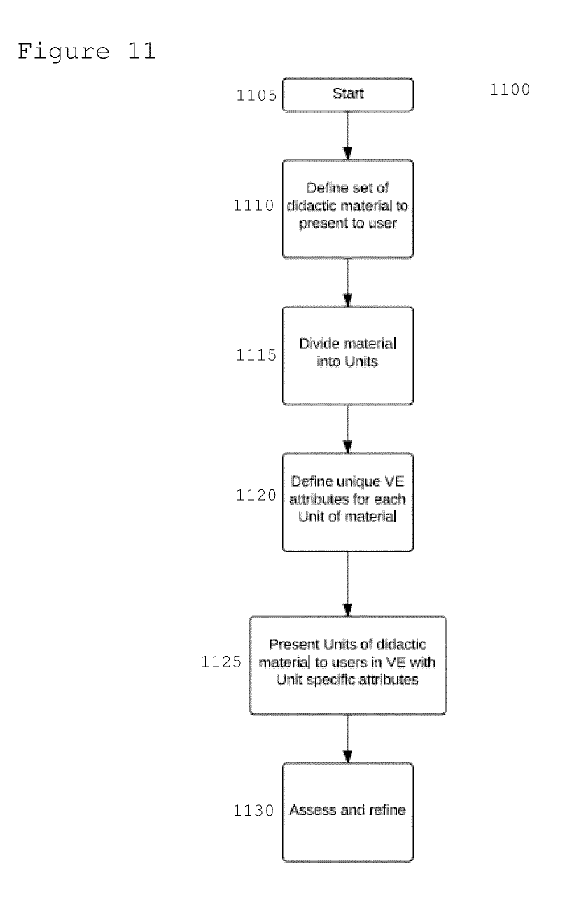

FIG. 11 is a flow chart depicting the method 1100 for presenting didactic media to a user in a virtual environment, according to one embodiment disclosed herein. It should be recognized by one of ordinary skill in the art that the particular order of steps in the method 1100 is just one embodiment, and any suitable order may be used to implement the functionality of the method 1100. The method start 1105 by selecting a topic about which to present didactic material. For example vocabulary words or molecular structures or the like At step 1110 the topic is refined by defining a set of didactic material to be presented to a user, for example which vocabulary words, molecular structures or the like. At 1115 the set of didactic material is divided into units or sub sets. At 1120 unique VE's are defined by assigning attributes to the VEs and assigned to each unit or subset of didactic material to be presented to a user. At 1125 the units of didactic material are presented to users such that each unit of didactic material is presented in a VE with unique attributes. At 1130 user retention of didactic material is assessed and the didactic presentation may be refined to aid in the retention of material the user is having difficulty with.

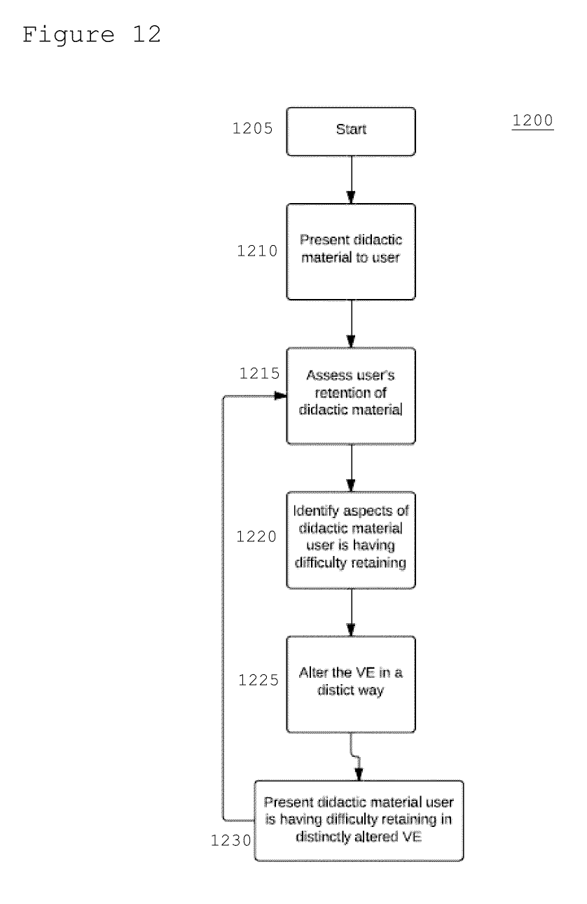

FIG. 12 is a flow chart depicting the method 1200 for improving retention of didactic material in a user, according to one embodiment disclosed herein. It should be recognized by one of ordinary skill in the art that the particular order of steps in the method 1200 is just one embodiment, and any suitable order may be used to implement the functionality of the method 1200. The method starts 1205 by selecting didactic material to be presented to a user. The didactic material is then presented to the user 1210, in some cases as described in more detail above. At step 1215 the user's retention of the didactic material is assessed, as in for example, by presenting the user with a quiz. Using the assessment 1215, the method identifies aspects of the didactic material the user is having difficulty retaining 1220. The method then alters the VE in a distinct way at step 1225 to create a VE with unique attributes and presents the didactic material the user is having difficulty retaining in the distinctly altered VE 1230. The method then returns to step 1215 for assessment and continued refinement.

### Examples

### 1

A performer reads the text of a book. The audio portion of the performance is captured via any method of audio capture known to those skilled in the art. While the performer is reading the text, the motion of the performer, including the performer's facial expressions are captured through any motion capture methods known to those skilled in the art. The audio data and motion capture data are stored in a suitable medium.

The audio program is mapped and tagged with various VEFTs. This can be done in any way known to those skilled in the art. For example the audio program can be played to a coder. The coder's responsibility is to note substantive elements of the media program such as settings, plot elements and the like, as a function of elapsed time in the audio program. The coder's notations are then inserted into the audio file at the appropriate time as VEFTs such that the setting tags coincide with the audio.

Virtual environments are provided either as a separate computer readable file or as part of the media file. The virtual environments are capable of being rendered by a computer. The virtual environments may be dynamic, capable of taking on various attributes. As the media program progresses, the computing device that renders the virtual environment reads the setting tags and causes attributes of the virtual environment to change in accordance with the setting tags by inserting various effects/assets.

The virtual environment may further comprise a virtual performer. The motion capture data from the real life performer is mapped onto the virtual performer such that the movements of the virtual performer in the virtual environment match the movements of the real life performer.

### 2

A user obtains a computer readable file comprising an audio portion where the audio portion further comprises setting tags that indicate setting elements as a function of elapsed time in the audio program. The user also obtains a computer readable file which encodes at least one virtual environment. The virtual environments may further comprise various attributes. The virtual environment file(s) may be separate from or part of the file that contains the audio program.

The user puts on a head mounted display capable of displaying an immersive virtual environment to the user. The user initiates playing of the audio program. As the audio program progresses, the computer that renders the virtual environment may change the attributes of the virtual environment in response to the setting tags associated with the audio program such that the user experiences changes in the virtual environment that are substantively related to the audio program.

### 3

A method for providing an audio program to at least one user comprising: Providing a virtual environment to at least one user; causing/allowing an audio program to be played to the at least one user in the virtual environment.

Where the audio program is an audiobook.

Where the audio program is a lecture.

Where the audio program is a musical performance.

Where the audio program is a play.

Where the virtual environment is appointed to match the content of the audio program.

Where the matching is based on thematic elements of an audiobook or musical performance.

Where the matching is based on the setting of an audiobook.

Where the appointment of the virtual environment changes in accordance with the current content of the audiobook.

Where the audio program is presented in the virtual environment by an agent.

Where the agent is anthropomorphic

Where the agent non-anthropomorphic

Where the non-anthropomorphic agent is a fire

Where the anthropomorphic agent moves while presenting the audio program.

Where the anthropomorphic agents movements are based on motion capture data from a person performing the audio program.

Where the anthropomorphic agent's movements are based on motion capture data from a person mimicking the performance of the audio program.

Where the captured motions are facial expressions.

Where the method further comprises the step of tagging various sections of the audio program with thematic or setting tags.

Where the method further comprises the step of compiling a plurality of virtual environments to match the thematic or setting tags.

Where the setting tags are related to the physical location of events in an audiobook

Where the setting tags are related to the weather conditions in an audiobook.

Where the virtual environment is networked to allow multiple users in varied real world locations to enter the virtual environment at the same time and hear the audio program together.

Where users are represented in the VE by avatars.

Where the virtual environment further comprises book shelves holding books and the selection of an audio book is accomplished by interacting with the book on the book shelf.

Where the VE is presented to a user on a head mounted display.

A system for the presentation of an audio program comprising: a head mounted display capable of displaying an immersive environment to a user; a computer readable file comprising the audio program, where the file further comprises setting tags; at least one virtual environment capable of being rendered by the display, the virtual environment in communication with the computer readable file, where the virtual environment is capable of changing in response to the setting tags; and an audio delivery device capable of delivering sound to a user.

An audio file adapted to be operatively linked to an adaptive virtual environment, the adaptive virtual environment further comprising variable attributes, wherein the audio file further comprises setting tags, and where the setting tags communicate changes to the attributes of the virtual environment.

A method for producing an audio program comprising the steps of recording the audio program, motion capturing the performer of the audio program, and designing a virtual environment adapted for listening to the audio program, as in, for example by incorporating setting and/or thematic elements of the audio program into the virtual environment.

where attributes in the virtual environment change in relation to the progression of the audio program.

A computer readable file comprising: audio data; motion capture data of a performer, wherein the performer recorded the audio data; setting tags that indicate setting elements associated with the audio data

Where the computer readable file further comprises data encoding a virtual environment.

Where the virtual environment further comprises attributes that change in response to the setting tags.

A method for creating an immersive environment for experiencing a story comprising tagging a story with setting tags

What is claimed is:

1. A method for presenting media to a user in a virtual environment (VE) comprising:
rendering a VE in which a user will consume media;
receiving a user's selection of media;
presenting the media to the user;
tracking a position of the media;
determining a context of the media; and
altering the VE in response to the determination of the context of the media.

2. The method of claim 1 wherein the determining of a context of the media is accomplished by a detection of a plurality of virtual environment function tags (VEFTs).

3. The method of claim 1 wherein the media is an audio book.

4. The method of claim 1 wherein the media is a movie.

5. The method of claim 1 wherein the media is a television show.

6. The method of claim 1 wherein the media is didactic material

7. A method for coding media for consumption in a VE comprising:
selecting a media file to be coded;
loading the media file to be coded into a media coding program;
collecting data respecting a plurality of substantive elements of the media file to be coded; and
tagging the media file with a plurality of virtual environment function tags (VEFTs).

8. The method of claim 7 wherein the media is an audio book.

9. The method of claim 7 wherein the media is a movie.

10. The method of claim 7 wherein the media is a television show.

11. The method of claim 7 wherein the media is didactic material.

12. A virtual environment for the consumption of media comprising:
a plurality of 3D models;
a plurality of effects;
a media player; and
wherein the virtual environment changes in response to substantive elements of the media being consumed in the virtual environment.
